(19) United States
(12) Patent Application Publication
(10) Pub. No.: US 2023/0196074 A1
(43) Pub. Date: Jun. 22, 2023

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Yuki TAGAWA, Tokyo (JP); Ryota Ozaki, Tokyo (JP); Tomoki Taniguchi, Tokyo (JP); Tomoko Ohkuma, Tokyo (JP)

(73) Assignee: FUJIFILM Corporation, Tokyo (JP)

(21) Appl. No.: 18/066,281

(22) Filed: Dec. 15, 2022

(30) Foreign Application Priority Data
Dec. 21, 2021 (JP) 2021-207602

(51) Int. Cl. G06N 3/0455; G06N 3/096; G06F 40/295; G06F 40/30

(52) U.S. Cl. CPC G06N 3/0455; G06N 3/096; G06F 40/295; G06F 40/30

(57) ABSTRACT

An information processing apparatus comprising at least one processor, wherein the at least one processor is configured to: derive a reliability degree of a trained teacher model based on training data used for training the teacher model and predetermined sample data; derive an output target based on output data obtained by inputting the sample data to the teacher model and the reliability degree; and train a student model such that output data obtained by inputting the sample data to the student model approaches the output target.

### CROSS-REFERENCE TO RELATED APPLICATIONS

The present application claims priority under 35 U.S.C. § 119 to Japanese Patent Application No. 2021-207602, filed on Dec. 21, 2021. The above application is hereby expressly incorporated by reference, in its entirety, into the present application.

### BACKGROUND

### Technical Field

The present disclosure relates to an information processing apparatus, an information processing method, and an information processing program.

### Related Art

In the related art, image diagnosis is performed using medical images obtained by imaging apparatuses such as computed tomography (CT) apparatuses and magnetic resonance imaging (MRI) apparatuses. In addition, medical images are analyzed via computer aided detection/diagnosis (CAD) using a discriminator in which learning is performed by deep learning or the like, and regions of interest including structures, lesions, and the like included in the medical images are detected and/or diagnosed. The medical images and analysis results via CAD are transmitted to a terminal of a healthcare professional such as a radiologist who interprets the medical images. The healthcare professional such as a radiologist interprets the medical image by referring to the medical image and analysis result using his or her own terminal and creates an interpretation report.

In addition, various methods have been proposed to support the creation of interpretation reports in order to reduce the burden of the interpretation work of a radiologist. For example, JP2019-153250A discloses a technique for creating an interpretation report based on a keyword input by a radiologist and an analysis result of a medical image. In the technique described in JP2019-153250A, a sentence to be included in the interpretation report is created by using a recurrent neural network trained to generate a sentence from input characters.

In addition, various methods for analyzing the content of a sentence using a natural language, such as an interpretation report, have been proposed. For example, “Single-/Multi-Source Cross-Lingual NER via Teacher-Student Learning on Unlabeled Data in Target Language”, Qianhui Wu et al., in ACL (Association for Computational Linguistics), 2020 discloses a method using “distillation” as a model learning method for recognizing a named entity in a sentence. The “distillation” is a learning method in which the output of an unlearned model (so-called “student model”) is brought closer to the output of a trained model (so-called “teacher model”) in a case where the student model is trained. In the technique disclosed in “Single-/Multi-Source Cross-Lingual NER via Teacher-Student Learning on Unlabeled Data in Target Language”, Qianhui Wu et al., in ACL (Association for Computational Linguistics), 2020, an unlearned model (student model) related to a target language is trained by ensemble learning using a plurality of trained models related to different source languages as teacher models. Further, in the ensemble learning, it is disclosed that a weight corresponding to a linguistic similarity degree between a source language and a target language is used.

In the model learning method using distillation, the student model is trained based on the output of the teacher model. Therefore, the performance of the student model depends on the performance of the teacher model. Therefore, for example, in a case where there is a teacher model having an inappropriate output, a student model having desired performance may not be obtained even though learning using distillation is performed.

### SUMMARY

The present disclosure provides an information processing apparatus, an information processing method, and an information processing program that can obtain a learning model having favorable performance.

According to a first aspect of the present disclosure, there is provided an information processing apparatus comprising at least one processor, and the processor is configured to: derive a reliability degree of a trained teacher model based on training data used for training the teacher model and predetermined sample data; derive an output target based on output data obtained by inputting the sample data to the teacher model and the reliability degree; and train a student model such that output data obtained by inputting the sample data to the student model approaches the output target.

In the first aspect, the processor may be configured to: derive the reliability degree for each of a plurality of the teacher models different from each other; and derive, as the output target, a weighted average according to the reliability degrees with respect to a plurality of pieces of output data obtained by inputting the sample data to each of the plurality of teacher models.

In the first aspect, the processor may be configured to derive the reliability degree based on a similarity degree between the training data and the sample data.

In the first aspect, the processor may be configured to: in a case where there are a plurality of pieces of the training data, derive a similarity degree with the sample data for each piece of the training data; and derive the reliability degree based on an average of all the similarity degrees derived for each piece of the training data.

In the first aspect, the processor may be configured to: in a case where there are a plurality of pieces of the training data, derive a similarity degree with the sample data for each piece of the training data; and derive the reliability degree based on an average of the similarity degrees selected by a predetermined number in descending order of the similarity degrees among all the similarity degrees derived for each piece of the training data.

In the first aspect, the training data may include a combination of training input data and training correct answer data serving as output data in a case where the training input data is input to the teacher model, and the processor may be configured to derive the reliability degree based on a loss value representing a magnitude of an error of output data obtained by inputting the training input data to the teacher model with respect to the training correct answer data.

In the first aspect, the processor may be configured to derive the reliability degree based on an evaluation value representing a degree of matching of output data obtained by inputting evaluation input data included in evaluation data to the teacher model with evaluation correct answer data, the evaluation data including a combination of the evaluation input data and the evaluation correct answer data serving as output data in a case where the evaluation input data is input to the teacher model.

In the first aspect, the processor may be configured to train the student model such that a loss value representing a magnitude of an error of the output data obtained by inputting the sample data to the student model with respect to the output target is minimized.

In the first aspect, the processor may be configured to derive the loss value using at least one measure of cross entropy, Kullback-Leibler divergence, or mean squared error.

In the first aspect, the teacher model and the student model may be models in which an input is text data and an output is classification for each character included in the text data, the training data may include a combination of text data and classification for each character included in the text data, and the sample data may include text data.

In the first aspect, the processor may be configured to derive the reliability degree based on a similarity degree with respect to at least one of a meaning, a structure, or appearance words between the text data included in the training data and the text data included in the sample data.

In the first aspect, the teacher model and the student model may be models in which an input is text data and an output is a probability distribution of an NE label indicating a type of named entity represented by the character, which is given for each character included in the text data, and the processor may be configured to: derive an output target based on the probability distribution of the NE label obtained by inputting the sample data to the teacher model and the reliability degree; and train the student model such that the probability distribution of the NE label obtained by inputting the sample data to the student model approaches the output target.

In the first aspect, the teacher model and the student model may be models in which an input is text data and an output is a probability distribution of a BIO label indicating whether the character corresponds to any of a start position, an internal position, and an external position of the named entity, which is given for each character included in the text data, and the processor may be configured to: derive an output target based on the probability distribution of the BIO label obtained by inputting the sample data to the teacher model and the reliability degree; and train the student model such that the probability distribution of the BIO label obtained by inputting the sample data to the student model approaches the output target.

According to a second aspect of the present disclosure, there is provided an information processing method comprising: deriving a reliability degree of a trained teacher model based on training data used for training the teacher model and predetermined sample data; deriving an output target based on output data obtained by inputting the sample data to the teacher model and the reliability degree; and training a student model such that output data obtained by inputting the sample data to the student model approaches the output target.

According to a third aspect of the present disclosure, there is provided an information processing program for causing a computer to execute a process comprising: deriving a reliability degree of a trained teacher model based on training data used for training the teacher model and predetermined sample data; deriving an output target based on output data obtained by inputting the sample data to the teacher model and the reliability degree; and training a student model such that output data obtained by inputting the sample data to the student model approaches the output target.

According to the above-described aspects, the information processing apparatus, the information processing method, and the information processing program of the present disclosure can obtain a learning model having favorable performance.

### BRIEF DESCRIPTION OF THE DRAWINGS

FIG. 1 is a schematic configuration diagram of an information processing system.

FIG. 2 is a block diagram showing an example of a hardware configuration of an information processing apparatus.

FIG. 3 is a diagram illustrating a named entity recognition model.

FIG. 4 is a diagram illustrating a named entity recognition model.

FIG. 5 is a diagram illustrating a model learning method using distillation.

FIG. 6 is a block diagram showing an example of a functional configuration of the information processing apparatus.

FIG. 7 is a diagram illustrating a function of the information processing apparatus.

FIG. 8 is a diagram showing an example of sample data and training data.

FIG. 9 is a diagram illustrating a similarity degree between the sample data and the training data.

FIG. 10 is a diagram illustrating learning of a student model.

FIG. 11 is a flowchart showing an example of information processing.

FIG. 12 is a diagram illustrating learning of a student model.

### DETAILED DESCRIPTION

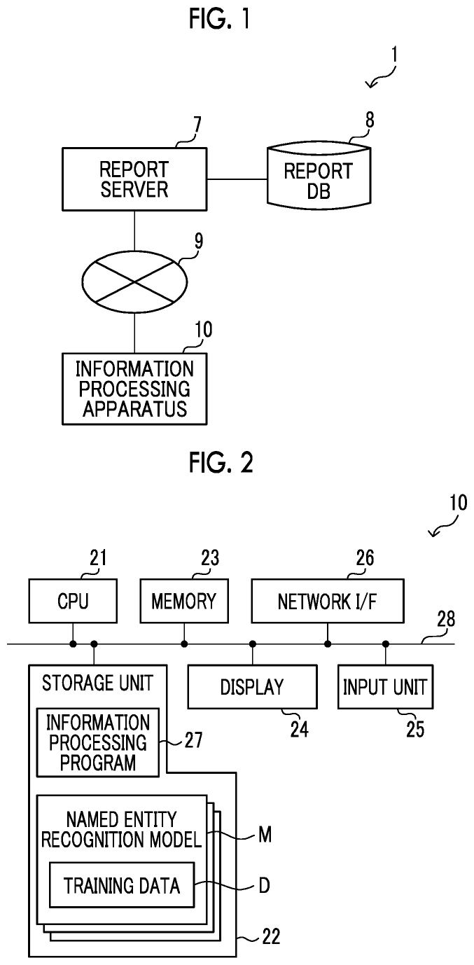

Hereinafter, form examples for implementing a technique of the present disclosure will be described in detail with reference to the drawings. First, with reference to FIG. 1, an example of a configuration of an information processing system 1 according to the present embodiment will be described. As shown in FIG. 1, the information processing system 1 includes an information processing apparatus 10, a report server 7, and a report DB 8. The information processing apparatus 10 and the report server 7 are connected to each other in a state in which they can communicate with each other via a wired or wireless network 9 such as a local area network (LAN) and a wide area network (WAN).

The report server 7 is a general-purpose computer on which a software program that provides a function of a database management system is installed. The report server 7 is connected to the report DB 8. The connection form between the report server 7 and the report DB 8 is not particularly limited, and may be a form connected by a data bus, or a form connected to each other via a network such as a network attached storage (NAS) and a storage area network (SAN).

The report DB 8 is realized by, for example, a storage medium such as a hard disk drive (HDD), a solid state drive (SSD), and a flash memory. In the report DB 8, for example, an interpretation report including comments on findings regarding a medical image is recorded. The interpretation report recorded in the report DB 8 may include the comments on findings input by the user or may include the comments on findings generated by a computer. For example, a comment on findings generated by a trained model such as convolutional neural network (CNN), which has been trained in advance such that the input is a medical image and the output is a comment on findings regarding abnormal shadows such as lesions included in the medical image, may be included. In addition, for example, a comment on findings generated by using a predetermined template may be included.

The information processing apparatus 10 trains a learning model for recognizing a named entity included in the interpretation report to obtain a learning model having favorable performance. An example of a configuration of the information processing apparatus 10 according to the present embodiment will be described below.

First, with reference to FIG. 2, an example of a hardware configuration of the information processing apparatus 10 according to the present embodiment will be described. As shown in FIG. 2, the information processing apparatus 10 includes a central processing unit (CPU) 21, a non-volatile storage unit 22, and a memory 23 as a temporary storage area. Further, the information processing apparatus 10 includes a display 24 such as a liquid crystal display, an input unit 25 such as a keyboard and a mouse, and a network interface (I/F) 26. The network I/F 26 is connected to the network 9 and performs wired or wireless communication. The CPU 21, the storage unit 22, the memory 23, the display 24, the input unit 25, and the network I/F 26 are connected to each other via a bus 28 such as a system bus and a control bus so that various types of information can be exchanged.

The storage unit 22 is realized by, for example, a storage medium such as a hard disk drive (HDD), a solid state drive (SSD), and a flash memory. An information processing program 27 and a plurality of named entity recognition models M in the information processing apparatus 10 are stored in the storage unit 22. The CPU 21 reads out the information processing program 27 from the storage unit 22, loads the read-out program into the memory 23, and executes the loaded information processing program 27. The CPU 21 is an example of a processor of the present disclosure. As the information processing apparatus 10, for example, various computers such as a personal computer and a server computer can be applied.

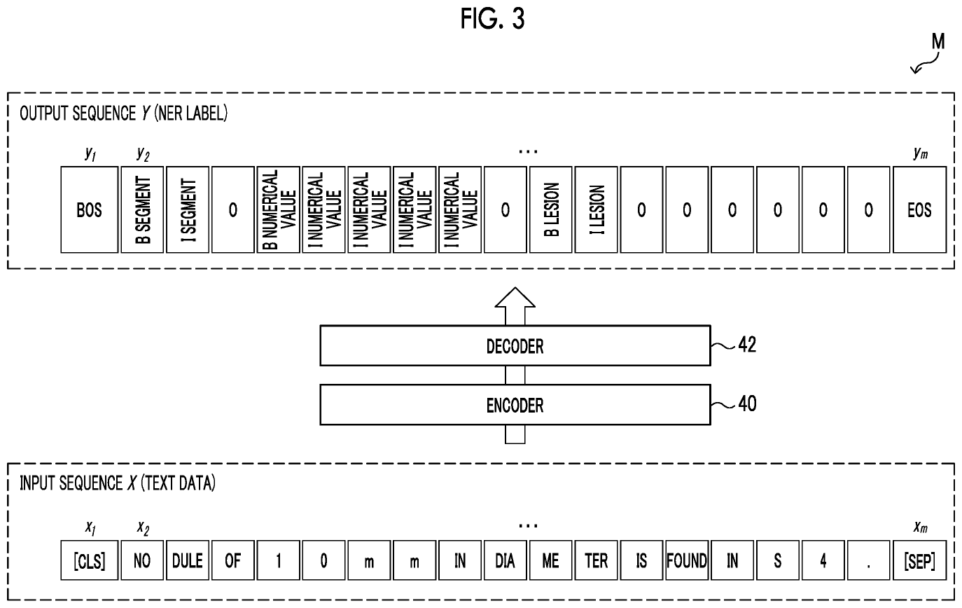

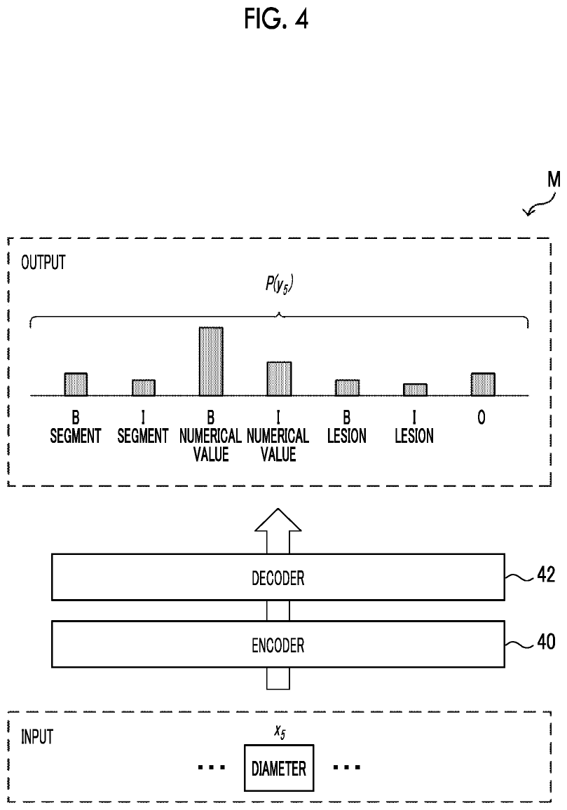

The named entity recognition model M according to the present embodiment will be described with reference to FIGS. 3 and 4. FIGS. 3 and 4 are diagrams showing a configuration of the named entity recognition model M and an example of inputs and outputs. As shown in FIG. 3, the named entity recognition model M is a model whose input is text data including a character string, and whose output is a probability distribution of named entity recognition (NER) labels indicating classification for each character (token) included in the text data. In addition, the named entity recognition model M comprises an encoder 40 and a decoder 42.

Specifically, as shown in FIG. 3, an input sequence X of the named entity recognition model M is text data consisting of m characters xᵢ (m is an integer of 2 or more, and i is 1 to m). The encoder 40 includes a natural language processing model such as bidirectional encoder representations from transformers (BERT) and long short term memory (LSTM), and obtains a distributed representation from the input sequence X.

FIG. 4 is a diagram showing a part of FIG. 3 and showing a probability distribution P(y₅) of the NER label corresponding to one character x₅ in the input sequence X. The decoder 42 includes, for example, a fully connected layer, and outputs a probability distribution P(yᵢ) of the NER label for each character xᵢ based on the distributed representation for each character xᵢ output from the encoder 40. The probability distribution P(yᵢ) indicates a probability for each of z types of NER labels in a case where only z types of NER labels (z is an integer of 2 or more) are prepared.

The NER label is a label indicating a combination of a named entity (NE) label indicating the type of the named entity represented by the character xᵢ, and a BIO label indicating whether the character xᵢ corresponds to any of the start position (Begin), internal position (Inside), and external position (Other) of the named entity. The NE label indicates the type of the named entity represented by the character xᵢ (for example, “segment”, “numerical value”, “lesion”, and the like), and the BIO label indicates the delimiter of the named entity.

Note that, for ease of understanding, only one type of NER label yᵢ selected based on the probability distribution P(yᵢ) is shown in FIG. 3. For example, in the case of the probability distribution P(y₅) in FIG. 4, since the probability of the NER label of the “B numerical value” is the highest, the “B numerical value” is shown as an NER label y₅ corresponding to the character x₅.

Further, in FIG. 3, a special token [CLS] indicating the beginning of a sentence is inserted at the beginning of the input sequence X, and a special token [SEP] indicating a delimiter of a sentence is inserted at the end of the input sequence X. An NER label “BOS (Beginning Of Sentence)” indicating the beginning of a sentence is output for [CLS], and an NER label “EOS (End Of Sentence)” indicating the end of the sentence is output for [SEP].

The learning of the named entity recognition model M is performed based on training data D including a combination of training input data and training correct answer data as output data in a case where the training input data is input to the named entity recognition model M. That is, the training data D is so-called labeled data. Specifically, the training input data is text data similar to the input sequence X. The training correct answer data is an NER label indicating classification for each character included in the text data, similar to an output sequence Y.

The input sequence X, the output sequence Y, and the training data D of the named entity recognition model M are represented as follows, for example. In addition, in Equations (1) to (3), the training input data is X, and the training correct answer data is Y.

$$X = \{ {x}_{1} , {x}_{2} , … , {x}_{i} , … , {x}_{m} \} \qquad ( 1 )$$

$$Y = \{ {y}_{1} , {y}_{2} , … , {y}_{i} , … , {y}_{m} \} \qquad ( 2 )$$

$$\begin{matrix}D = \{ ( Y , X ) \} \\ = \{ ( {y}_{1} , {x}_{1} ) , ( {y}_{2} , {x}_{2} ) , … , ( {y}_{i} , {x}_{i} ) , … , ( {y}_{m} , {x}_{m} ) \}\end{matrix} \qquad ( 3 )$$

The learning of the named entity recognition model M based on the training data D is performed by a method using a known loss function. As an example of the loss function, a negative log-likelihood function L_{NLL} is shown below. The learning of the named entity recognition model M is performed so as to minimize the negative log-likelihood function L_{NLL}.

$${L}_{NLL} = - {\sum }_{i = 1}^{m} log P ( {y}_{i} \vert {x}_{i} ) \qquad ( 4 )$$

A plurality of trained named entity recognition models M are stored in the storage unit 22 in association with the training data D used for training. Each of the plurality of named entity recognition models M stored in the storage unit 22 is a model whose input is text data and whose output is the probability distribution of the NER label. However, because the contents of the training data D are different or the parameters are different, even though the same input sequence X is input to each of the plurality of named entity recognition models M, different output sequence Y may be obtained.

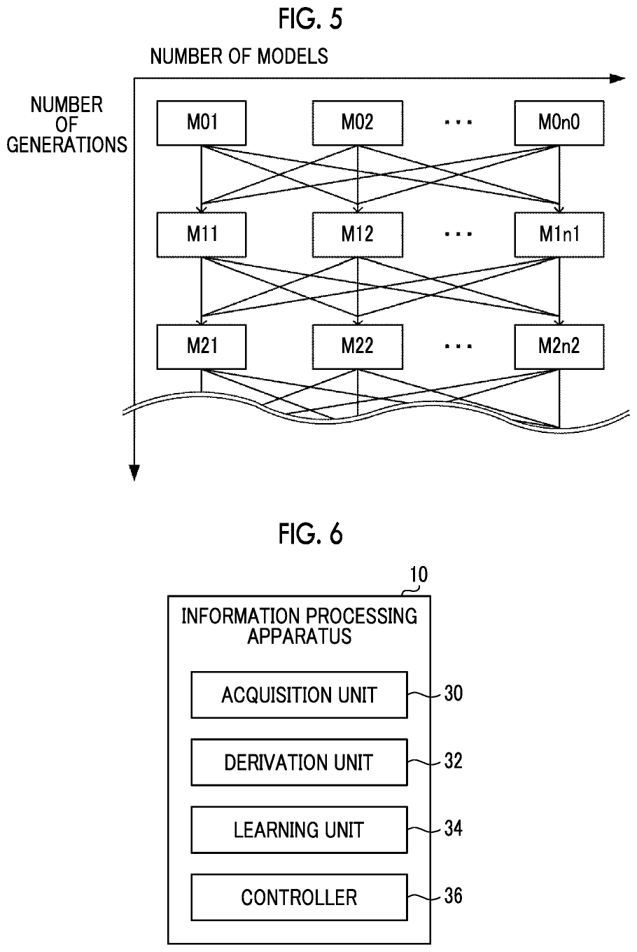

An outline of a learning method of the named entity recognition model M using “distillation” will be described with reference to FIG. 5. The “distillation” is a learning method in which the output of a student model is brought closer to the output of a trained named entity recognition model M (hereinafter referred to as a “teacher model”) in a case where an unlearned named entity recognition model M (hereinafter referred to as a “student model”) is trained.

For example, in FIG. 5, a case where trained named entity recognition models M01 to M0n0 (n0 is 2 or more) is used as a teacher model and an unlearned named entity recognition model M11 is used as a student model will be described. First, by inputting predetermined sample data to each of the named entity recognition models M01 to M0n0, output data is obtained from each of the named entity recognition models M01 to M0n0. Similarly, by inputting the sample data to the named entity recognition model M11 to be trained, output data is obtained from the named entity recognition model M11. The sample data input to each of the named entity recognition models M01 to M0n0 and M11 is the same.

Next, an output target used for training of the named entity recognition model M11 is derived based on the output data of the named entity recognition models M01 to M0n0, and training of the named entity recognition model M11 is performed such that the output data of the named entity recognition model M11 approaches the output target. From the named entity recognition model M11 trained in this manner, it can be expected that good output data in which variations in output data that may occur in each of the named entity recognition models M01 to M0n0 are suppressed is output. Note that, for the named entity recognition model M11, in addition to the learning using the sample data, normal learning based on the training data D prepared in advance for the named entity recognition model M11 is also performed.

Similarly to the training of the named entity recognition model M11, named entity recognition models M12 to M1n1 (n1 is 2 or more) are also trained based on the output data of the named entity recognition models M01 to M0n0. The named entity recognition models M12 to M1n1 may differ from the named entity recognition model M11 in terms of training data D, parameters, and the like.

After that, training is repeated using the named entity recognition models M11 to M1n1 after training as next-generation teacher models and named entity recognition models M21 to M2n2 (n2 is 2 or more) to be newly trained as student models. In this way, according to the model learning method using “distillation” in which the training of the student model is repeated with the trained student model as the next-generation teacher model, it can be expected that the named entity recognition model M with higher performance can be obtained as generations pass.

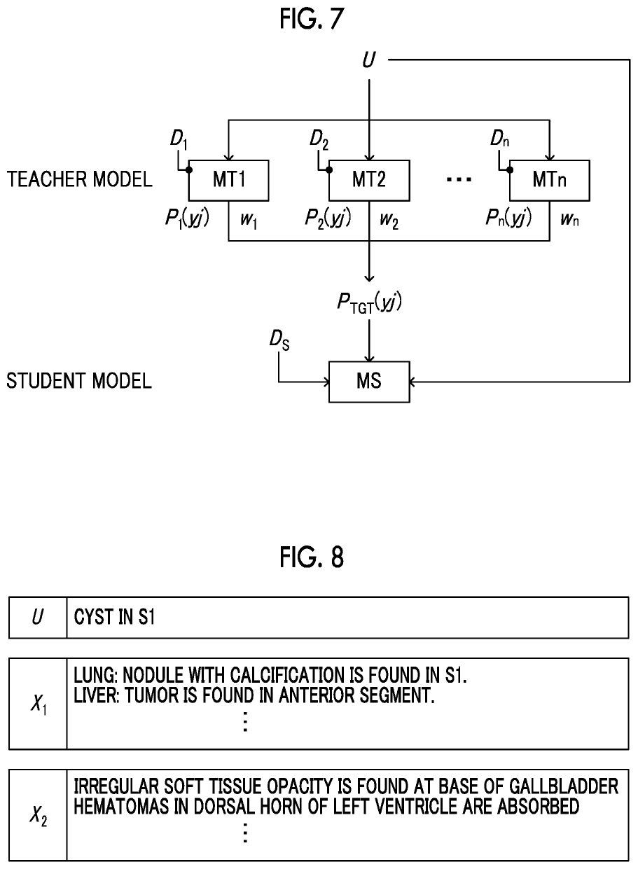

Next, with reference to FIGS. 6 to 10, an example of a functional configuration of the information processing apparatus 10 according to the present embodiment will be described. As shown in FIG. 6, the information processing apparatus 10 includes an acquisition unit 30, a derivation unit 32, a learning unit 34, and a controller 36. The CPU 21 executes the information processing program 27 to function as the acquisition unit 30, the derivation unit 32, the learning unit 34, and the controller 36. Hereinafter, a form example in which a student model MS is trained based on a plurality of teacher models MT1 to MTn (n is 2 or more) will be described as shown in FIG. 7. The teacher models MT1 to MTn and the student model MS are named entity recognition models M stored in the storage unit 22.

The acquisition unit 30 acquires training data D₁ to Dₙ used for training the trained teacher models MT1 to MTn and predetermined sample data U. As an example, FIG. 8 shows training input data X₁ and X₂ included in the training data D₁ and D₂, and the sample data U. The training data D₁ to Dₙ are stored in the storage unit 22 in association with the teacher models MT1 to MTn. In the following description, in a case where the teacher models MT1 to MTn, the training data D₁ to Dₙ and the training input data X₁ to Xₙ are not distinguished from each other, they are simply referred to as teacher model MT, training data D, and training input data X.

The sample data U includes data (for example, text data) having the same format as the training input data X included in the training data D, and is represented as follows, for example. The sample data U is so-called unlabeled data that does not include correct answer data. In Equation (5), 1 is an integer of 2 or more, and j is 1 to 1.

[symbol]

={u₁,u₂, . . . ,uⱼ, . . . ,uᵢ} (5)

The derivation unit 32 derives a reliability degree w of the teacher model MT based on the training data D acquired by the acquisition unit 30 and the sample data U. Specifically, the derivation unit 32 derives a similarity degree s between the training input data X included in the training data D and the sample data U, and derives the reliability degree w based on the similarity degree s. In a case where the training input data X and the sample data U are text data, the similarity degree s may be, for example, a similarity degree with respect to at least one a meaning, a structure, or appearance words between the text data.

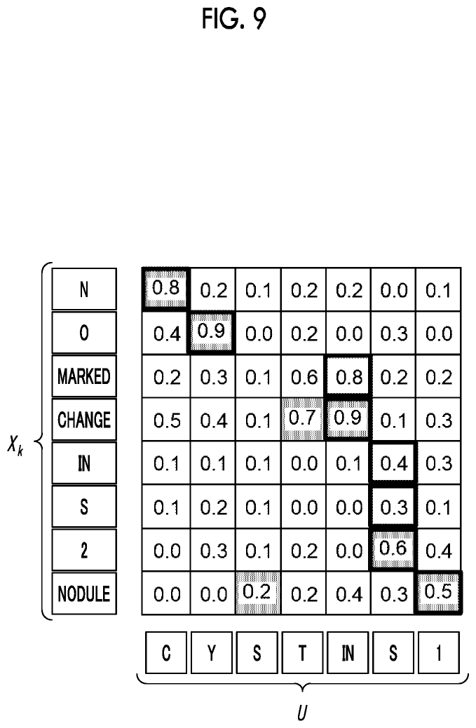

As an example, a method of deriving a semantic similarity degree s between text data using BERTScore will be described with reference to FIG. 9. FIG. 9 is a matrix showing the cosine similarity degree for each character of training input data Xₖ included in training data Dₖ used for training the k-th teacher model MTk (k is 1 to n) and the sample data U. The cosine similarity degree means that the closer it is to 1, the greater the similarity degree, and the closer it is to 0, the smaller the similarity degree. For example, the cosine similarity degree can be derived based on the distributed representation for each of the two pieces of text data derived using BERT.

A similarity degree sₖ is derived by the following Score function using the training input data Xₖ and the sample data U. As the Score function, at least one of the following Equations (7) to (9) can be applied, and these may be appropriately combined. Equations (7) to (9) are known BERTScores (for example, refer to the following literature, “BERTScore: Evaluating Text Generation with BERT”, Tianyi Zhang et al., in ICLR (International Conference on Learning Representations), 2020).

$${s}_{k} = Score ( U , {X}_{k} ) \qquad ( 6 )$$

$${R}_{BERT} = \frac{1}{\vert {X}_{k} \vert} {\sum }_{{x}_{i} ∈ {X}_{k}} {max}_{{u}_{j} ∈ U} {x}_{i}^{T} {u}_{j} \qquad ( 7 )$$

$${Q}_{BERT} = \frac{1}{\vert U \vert} {\sum }_{{u}_{j} ∈ U} {max}_{{x}_{i} ∈ {X}_{k}} {x}_{i}^{T} {u}_{j} \qquad ( 8 )$$

$${F}_{BERT} = 2 \frac{{Q}_{BERT} \cdot {R}_{BERT}}{{Q}_{BERT} + {R}_{BERT}} \qquad ( 9 )$$

R_{BERT} is an expression representing a recall rate, and is calculated using the maximum value of the cosine similarity degree with respect to the training input data Xₖ (value in which the background color is changed in FIG. 9) from the sample data U. R_{BERT} in the example of FIG. 9 is calculated as follows.

R_{BERT}=(0.8+0.9+0.2+0.7+0.9+0.6+0.5)/7=0.657

Q_{BERT} is an expression representing a matching rate, and is calculated using the maximum value of the cosine similarity degree with respect to the sample data U (value surrounded by a thick frame in FIG. 9) from the training input data Xₖ. Q_{BERT} in the example of FIG. 9 is calculated as follows.

Q_{BERT}=(0.8+0.9+0.8+0.9+0.4+0.3+0.6+0.5)/8=0.650

F_{BERT} is an expression representing an F value, and is a harmonized average of R_{BERT} (recall rate) and Q_{BERT} (matching rate). F_{BERT} in the example of FIG. 9 is calculated as follows.

F_{BERT}=2×(0.650×0.657)/(0.650+0.657)=0.653

The derivation unit 32 performs the derivation of the similarity degree sₖ for all the teacher models MT1 to MTn. Then, the derivation unit 32 normalizes similarity degrees s₁ to sₙ for each of the teacher models MT1 to MTn in the range of 0 to 1 using the Softmax function. The similarity degrees s₁ to sₙ after the normalization are reliability degrees w₁ to wₙ for each of the teacher models MT1 to MTn. In this way, the derivation unit 32 derives the reliability degrees w₁ to wₙ for each of the plurality of teacher models MT1 to MTn that are different from each other.

The similarity degrees s₁ to sₙ and the reliability degrees w₁ to wₙ for each of the teacher models MT1 to MTn are represented as follows.

$$S = \{ {s}_{1} , {s}_{2} , … , {s}_{k} , … , {s}_{n} \} \qquad ( 10 )$$

$$\begin{matrix}W = Softmax ( S ) \\ = \{ {w}_{1} , {w}_{2} , … , {w}_{k} , … , {w}_{n} \}\end{matrix} \qquad ( 11 )$$

The sample data U is one piece of text data, but a plurality of pieces of training data Dₖ may be present for one teacher model MTk. In this case, the derivation unit 32 may derive a similarity degree s with the sample data U for each of the plurality of pieces of training data Dₖ, and may derive a reliability degree wₖ based on at least one of the similarity degrees s. For example, the derivation unit 32 may use various representative values such as an average value, a median value, a maximum value, and a minimum value of all the similarity degrees s derived for each piece of training data Dₖ as the similarity degree sₖ used for deriving the reliability degree wₖ. Further, for example, the derivation unit 32 may use the average value of the similarity degrees s selected by a predetermined number in descending order of the similarity degrees s among all the similarity degrees s derived for each piece of training data Dₖ as the similarity degree sₖ used for deriving the reliability degree wₖ. The “predetermined number” may be determined, for example, by the number of pieces of data (for example, for 10 pieces or the like) or by a ratio (for example, the top 50% or the like).

Next, the derivation unit 32 derives an output target P_{TGT}(yⱼ), which is the target of bringing the output data (probability distribution Pₛ of the NER label) of the student model MS close to each other. Specifically, as shown in FIG. 7, the derivation unit 32 derives the output target P_{TGT}(yⱼ) based on probability distributions P₁(yⱼ) to Pₙ(yⱼ), which are output data obtained by inputting the sample data U to each of the teacher models MT1 to MTn, and the reliability degrees w₁ to wₙ.

The output target P_{TGT}(yⱼ=a|U) is represented as follows. The part of Pₖ(yⱼ=a|U) in Equation (12) indicates the probability that a certain NER label a is output for the j-th character uⱼ in a case where the sample data U is input to the teacher model MTk. The derivation unit 32 derives, as the output target P_{TGT}(yⱼ), a weighted average according to the reliability degrees w₁ to wₙ with respect to the probability distributions P₁(yⱼ) to Pₙ(yⱼ), which are a plurality of pieces of output data obtained by inputting the sample data U to each of the plurality of teacher models MT1 to MTn.

$${P}_{TGT} ( {y}_{j} = a \vert U ) = \frac{1}{n} {\sum }_{k = 1}^{n} {w}_{k} {P}_{k} ( {y}_{j} = a \vert U ) \qquad ( 12 )$$

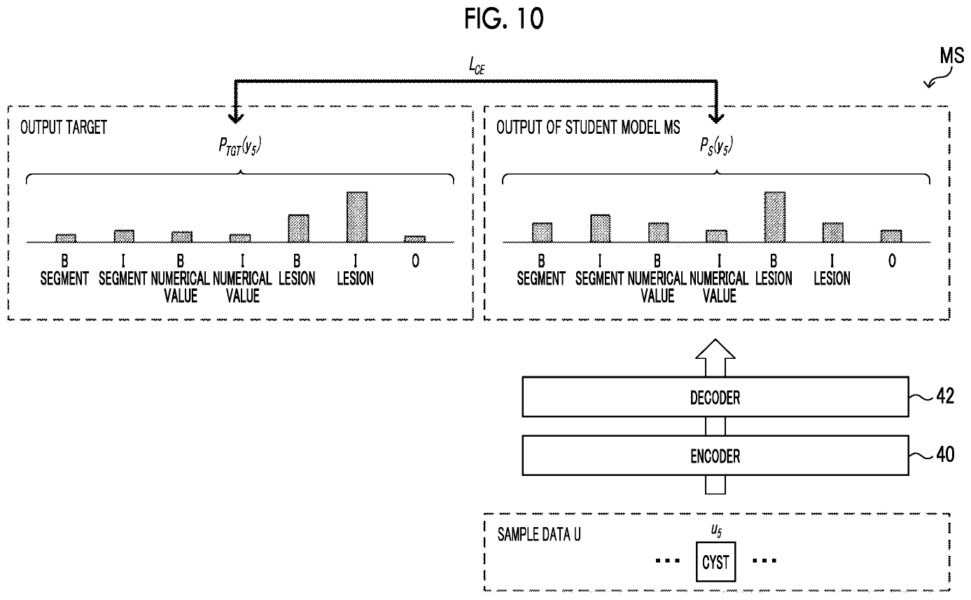

The learning unit 34 trains the student model such that the probability distribution Pₛ(yⱼ), which is output data obtained by inputting the sample data U to the student model MS, approaches the output target P_{TGT}(yⱼ) derived by the derivation unit 32. FIG. 10 shows an example of an output target P_{TGT}(y₅) corresponding to one character us of the sample data U and a probability distribution Pₛ(y₅) which is the output data of the student model MS. In order to bring the probability distribution Pₛ(y₅) (right side in FIG. 10) of the student model MS closer to the output target P_{TGT}(y₅) (left side in FIG. 10), it is sufficient to reduce the error between the probability distribution Pₛ(y₅) and the output target P_{TGT}(y₅).

Therefore, the learning unit 34 trains the student model MS such that a loss value representing a magnitude of an error of the probability distribution Pₛ(yⱼ), which is output data obtained by inputting the sample data U to the student model MS, with respect to the output target P_{TGT}(yⱼ) is minimized. The loss value can be derived using, for example, at least one measure of cross entropy, Kullback-Leibler divergence, or mean squared error.

As an example of the loss value, a cross entropy loss L_{CE} is represented below. In Equation (13), z represents the number of types of the NER label.

$${L}_{CE} = - \frac{1}{l} {\sum }_{j = 1}^{l} {\sum }_{a = 1}^{z} {P}_{TGT} ( {y}_{j} = a \vert U ) log {P}_{S} ( {y}_{j} = a \vert U ) \qquad ( 13 )$$

In addition, the learning unit 34 may perform learning based on training data D_{S} prepared in advance for the student model MS. The learning based on the training data D_{S} may be performed by a method using a known loss function as shown in Equation (4).

The controller 36 performs the distillation of the named entity recognition model M by controlling the acquisition unit 30, the derivation unit 32, and the learning unit 34 to repeat the processing. Specifically, in a case where the learning unit 34 completes learning of the student model MS, the controller 36 controls the acquisition unit 30, the derivation unit 32, and the learning unit 34 such that learning of the next-generation student model MS is started using the student model MS as the next-generation teacher model MT.

In addition, the controller 36 may operate the named entity recognition model M of any generation. For example, the controller 36 may acquire an interpretation report from the report server 7 via the network 9 in a case where a user gives an instruction via the input unit 25, and output an NER label by inputting the interpretation report to the named entity recognition model M of the latest generation. Further, for example, the controller 36 may recognize the named entity based on the BIO label included in the NER label, specify the type of the named entity based on the NE label, and present the named entity on the display 24.

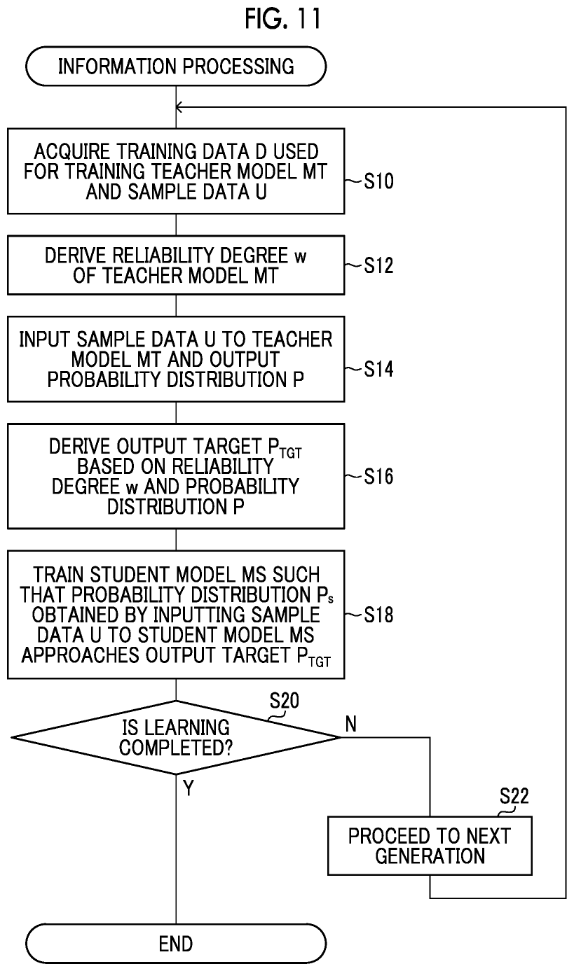

Next, with reference to FIG. 11, operations of the information processing apparatus 10 according to the present embodiment will be described. In the information processing apparatus 10, the CPU 21 executes the information processing program 27, and thus information processing shown in FIG. 11 is executed. The information processing is executed, for example, in a case where the user gives an instruction to start execution via the input unit 25.

In Step S10, the acquisition unit 30 acquires the training data D used for training the trained teacher model MT and the predetermined sample data U. In Step S12, the derivation unit 32 derives the reliability degree w of the teacher model MT based on the training data D acquired in Step S10 and the sample data U. In Step S14, the derivation unit 32 inputs the sample data U acquired in Step S10 to the teacher model MT and outputs the probability distribution P which is the output data. In Step S16, the derivation unit 32 derives the output target P_{TGT} based on the reliability degree w derived in Step S12 and the probability distribution P output in Step S14.

In Step S18, the learning unit 34 trains the student model MS such that the probability distribution Pₛ, which is the output data obtained by inputting the sample data U to the student model MS, approaches the output target P_{TGT} derived in Step S16. In Step S20, the controller 36 determines whether or not the learning using the distillation is completed. In a case where the learning is not completed (that is, in a case where Step S20 is N), the process proceeds to Step S22, and the controller 36 controls the acquisition unit 30, the derivation unit 32, and the learning unit 34 to perform the next-generation learning. Specifically, the controller 36 sets the student model MS whose learning is completed in Step S18 as the next-generation teacher model MT, and repeats the processes of Steps S10 to S18 with the next-generation student model MS as the learning target. On the other hand, in a case in which the learning is completed (that is, in a case in which Step S20 is Y), the present information processing ends.

As described above, the information processing apparatus 10 according to one aspect of the present disclosure comprises at least one processor, and the processor is configured to: derive a reliability degree w of a trained teacher model MT based on training data D used for training the teacher model MT and predetermined sample data U; derive an output target based on output data obtained by inputting the sample data U to the teacher model MT and the reliability degree w; and train a student model MS such that output data obtained by inputting the sample data U to the student model MS approaches the output target. That is, with the information processing apparatus 10 according to the present embodiment, in a learning method using “distillation” in which the student model MS is trained based on the teacher model MT, the weight of a teacher model MT with a relatively high reliability degree w can be increased, and the weight of a teacher model MT with a relatively low reliability degree w can be lightened. Therefore, the influence of the teacher model MT having favorable performance on the student model MS can be ensured, and the influence of the teacher model MT having inappropriate performance on the student model MS can be reduced. Therefore, a learning model (named entity recognition model M) having favorable performance can be obtained.

In the above-described embodiment, a form example in which the derivation unit 32 derives the similarity degree s between the training data D and the sample data U using the BERTScore has been described, but the present disclosure is not limited thereto. For example, the derivation unit 32 may derive the similarity degree s using another indicator such as term frequency-inverse document frequency (TF-IDF) in place of or in addition to BERTScore. By using TF-IDF, it is possible to derive the similarity degree s with respect to the appearance words between the text data.

In addition, in the above-described embodiment, a form example in which the reliability degree w of the teacher model MT is derived based on the similarity degree s between the training data D and the sample data U has been described, but the derivation unit 32 may derive the reliability degree w by appropriately combining indicators other than the similarity degree s.

For example, the derivation unit 32 may derive the reliability degree w based on the loss value of the teacher model MT. The loss value of the teacher model MT is a value representing an error of the probability distribution P(yⱼ), which is output data obtained by inputting the training input data X to the teacher model MT, with respect to the training correct answer data Y. The loss value can be derived using, for example, at least one measure of cross entropy, Kullback-Leibler divergence, or mean squared error. The derivation unit 32 may derive the reliability degree w such that the larger the loss value of the teacher model MT, the smaller the reliability degree w, and the smaller the loss value, the larger the reliability degree w.

Further, for example, the derivation unit 32 may derive the reliability degree w based on the evaluation value of the teacher model MT derived using evaluation data E. The evaluation data E is data including a combination of evaluation input data X_{E} and evaluation correct answer data Y_{E} as output data in a case where the evaluation input data X_{E} is input to the named entity recognition model M. The evaluation data E is data having the same format as the training data D and the sample data U but having different contents. The evaluation value of the teacher model MT is a value representing a degree of matching of the probability distribution P(yⱼ), which is output data obtained by inputting the evaluation input data X_{E} included in the evaluation data E to the teacher model MT, with the evaluation correct answer data Y_{E}. The derivation unit 32 may derive the reliability degree w such that the larger the evaluation value of the teacher model MT, the larger the reliability degree w, and the smaller the evaluation value, the smaller the reliability degree w.

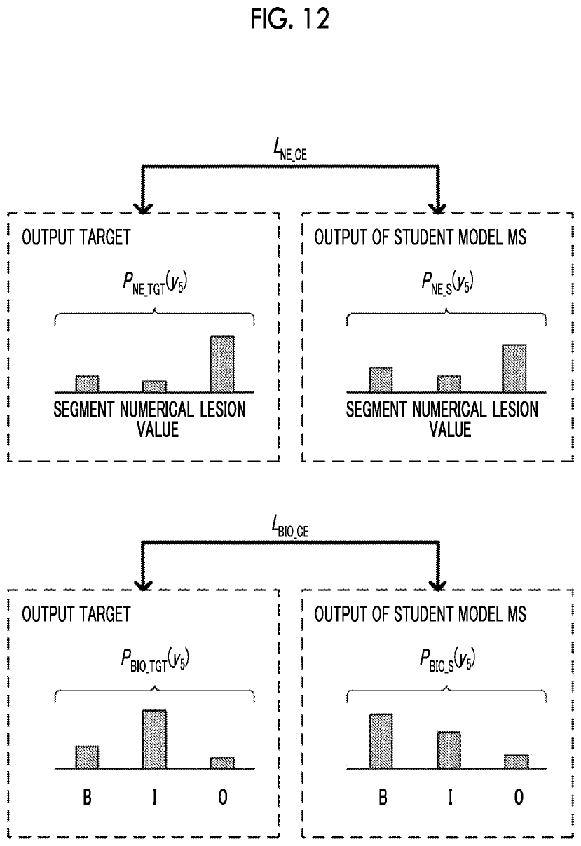

In addition, in the above-described embodiment, regarding the named entity recognition model M, the form in which the input is text data and the output is an NER label indicating a combination of the NE label and the BIO label has been described, but the output of the named entity recognition model M is not limited to the format of the NER label. For example, as shown in FIG. 12, the named entity recognition model M may divide the NER label into an NE label and a BIO label, and output at least one of the NE label or the BIO label. FIG. 12 is a diagram in which the NER label shown in FIG. 10 is divided into an NE label and a BIO label.

Specifically, the named entity recognition model M (that is, the teacher model MT and the student model MS) may be a model in which an input is text data and an output is a probability distribution P_{NE_S} (yⱼ) of an NE label indicating a type of named entity represented by the character, which is given for each character included in the text data. In this case, the derivation unit 32 derives an output target P_{NE_TGT}(yⱼ) based on the probability distribution P_{NE_S}(yⱼ) of the NE label obtained by inputting the sample data U to the teacher model MT and the reliability degree w. The learning unit 34 trains the student model MS such that the probability distribution P_{NE_S}(yⱼ) of the NE label obtained by inputting the sample data U to the student model MS approaches the output target P_{NE_TGT}(yⱼ), and a loss value L_{NE_CE} is minimized. The output target P_{NE_TGT}(yⱼ=a|U) is represented as follows.

$${P}_{NE \_ TGT} ( {y}_{j} = a \vert U ) = \frac{1}{n} {\sum }_{k = 1}^{n} {w}_{k} {P}_{NE \_ k} ( {y}_{j} = a \vert U ) \qquad ( 12 - 1 )$$

In addition, the named entity recognition model M (that is, the teacher model MT and the student model MS) may be a model in which an input is text data and an output is a probability distribution P_{BIO_S}(yⱼ) of a BIO label indicating whether the character corresponds to any of a start position, an internal position, and an external position of the named entity, which is given for each character included in the text data. In this case, the derivation unit 32 derives an output target P_{BIO_TGT}(yᵢ) based on the probability distribution P_{BIO_S}(yⱼ) of the BIO label obtained by inputting the sample data U to the teacher model MT and the reliability degree w. The learning unit 34 trains the student model MS such that the probability distribution P_{BIO_S}(yⱼ) of the BIO label obtained by inputting the sample data U to the student model MS approaches the output target P_{BIO_TGT}(yⱼ), and a loss value L_{BIO_CE} is minimized. The output target P_{BIO_TGT}(yⱼ=a|U) is represented as follows.

$${P}_{BIO \_ TGT} ( {y}_{j} = a \vert U ) = \frac{1}{n} {\sum }_{k = 1}^{n} {w}_{k} {P}_{BIO \_ k} ( {y}_{j} = a \vert U ) \qquad ( 12 - 2 )$$

The minimization of the loss value L_{NE_CE} for the NE label and the minimization of the loss value L_{BIO_CE} for the BIO label may be achieved more easily than the minimization of the loss value L_{CE} for the NER label. Therefore, the minimization of the loss value L_{NE_CE} for the NE label and the minimization of the loss value L_{BIO_CE} for the BIO label are separately learned for the student model MS, and thereby the student model MS may be trained more efficiently.

In addition, in the above-described embodiment, a form example in which the sample data U is unlabeled data including text data and not correct answer data has been described. However, the present disclosure is not limited thereto, and the sample data U may be labeled data including correct answer data. In this case, for example, the learning unit 34 may add the sample data U to the training data D_{S} in the learning of the student model MS. Further, for example, the derivation unit 32 may derive the magnitude of an error between the derived output target P_{TGT}(yⱼ) of the teacher model MT and the correct answer data included in the sample data U. Further, for example, using the magnitude of this error, the derivation unit 32 may determine that the correct answer data included in the sample data U is erroneously input in a case where the magnitude of the error is equal to or greater than a predetermined threshold value. Further, for example, in a case where it is determined that an erroneous input is made, the derivation unit 32 may correct the correct answer data included in the sample data U based on the output target P_{TGT}(yⱼ).

In addition, in the above-described embodiment, a form example in which the training data D of the named entity recognition model M is labeled data including correct answer data has been described. However, the present disclosure is not limited thereto, and the training data D may be unlabeled data not including correct answer data. That is, the named entity recognition model M may be a learning model trained by unsupervised learning.

In addition, in the above-described embodiment, a form example in which the student model MS is trained by ensemble learning of a plurality of teacher models MT1 to MTn has been described, but the present disclosure is not limited thereto. In the information processing apparatus 10 according to the present embodiment, it is also possible to train the student model MS based on one teacher model MT. In this case as well, in a case where the student model MS is trained in consideration of the weight based on the reliability degree w of the teacher model MT and the distillation is repeated, the degree of influence of the teacher model MT on the student model MS can be varied for each generation. For example, it is possible to inherit a large amount of the performance of the teacher model MT in a generation having relatively good performance and not to inherit much performance of the teacher model MT in a generation having relatively poor performance. Therefore, a student model MS having favorable performance can be obtained.

In addition, in the above-described embodiment, the form example in which the named entity recognition model M in which the input is the text data and the output is the probability distribution of the NER label is used as the learning target of the information processing apparatus 10 has been described, but the present disclosure is not limited thereto. The technique of the present disclosure can also be applied to, for example, a learning model for recognizing a region of interest including a lesion or the like from a medical image, in which the input is image data and the output is classification for each pixel.

In the above embodiments, for example, as hardware structures of processing units that execute various kinds of processing, such as the acquisition unit 30, the derivation unit 32, the learning unit 34, and the controller 36, various processors shown below can be used. As described above, the various processors include a programmable logic device (PLD) as a processor of which the circuit configuration can be changed after manufacture, such as a field programmable gate array (FPGA), a dedicated electrical circuit as a processor having a dedicated circuit configuration for executing specific processing such as an application specific integrated circuit (ASIC), and the like, in addition to the CPU as a general-purpose processor that functions as various processing units by executing software (program).

One processing unit may be configured by one of the various processors, or may be configured by a combination of the same or different kinds of two or more processors (for example, a combination of a plurality of FPGAs or a combination of the CPU and the FPGA). In addition, a plurality of processing units may be configured by one processor.

As an example in which a plurality of processing units are configured by one processor, first, there is a form in which one processor is configured by a combination of one or more CPUs and software as typified by a computer, such as a client or a server, and this processor functions as a plurality of processing units. Second, as represented by a system on chip (SoC) or the like, there is a form of using a processor for realizing the function of the entire system including a plurality of processing units with one integrated circuit (IC) chip. In this way, various processing units are configured by one or more of the above-described various processors as hardware structures.

Furthermore, as the hardware structure of the various processors, more specifically, an electrical circuit (circuitry) in which circuit elements such as semiconductor elements are combined can be used.

In the above embodiment, the information processing program 27 is described as being stored (installed) in the storage unit 22 in advance; however, the present disclosure is not limited thereto. The information processing program 27 may be provided in a form recorded in a recording medium such as a compact disc read only memory (CD-ROM), a digital versatile disc read only memory (DVD-ROM), and a universal serial bus (USB) memory. In addition, the information processing program 27 may be downloaded from an external device via a network. Further, the technique of the present disclosure extends to a storage medium for storing the information processing program non-transitorily in addition to the information processing program.

The technique of the present disclosure can be appropriately combined with the above-described embodiments. The described contents and illustrated contents shown above are detailed descriptions of the parts related to the technique of the present disclosure, and are merely an example of the technique of the present disclosure. For example, the above description of the configuration, function, operation, and effect is an example of the configuration, function, operation, and effect of the parts according to the technique of the present disclosure. Therefore, needless to say, unnecessary parts may be deleted, new elements may be added, or replacements may be made to the described contents and illustrated contents shown above within a range that does not deviate from the gist of the technique of the present disclosure.

What is claimed is:

1. An information processing apparatus comprising at least one processor, wherein the at least one processor is configured to:
derive a reliability degree of a trained teacher model based on training data used for training the teacher model and predetermined sample data;
derive an output target based on output data obtained by inputting the sample data to the teacher model and the reliability degree; and
train a student model such that output data obtained by inputting the sample data to the student model approaches the output target.

2. The information processing apparatus according to claim 1, wherein the at least one processor is configured to:
derive the reliability degree for each of a plurality of the teacher models different from each other; and
derive, as the output target, a weighted average according to the reliability degrees with respect to a plurality of pieces of output data obtained by inputting the sample data to each of the plurality of teacher models.

3. The information processing apparatus according to claim 1, wherein the at least one processor is configured to derive the reliability degree based on a similarity degree between the training data and the sample data.

4. The information processing apparatus according to claim 3, wherein the at least one processor is configured to:
in a case where there are a plurality of pieces of the training data, derive a similarity degree with the sample data for each piece of the training data; and
derive the reliability degree based on an average of all the similarity degrees derived for each piece of the training data.

5. The information processing apparatus according to claim 3, wherein the at least one processor is configured to:
in a case where there are a plurality of pieces of the training data, derive a similarity degree with the sample data for each piece of the training data; and
derive the reliability degree based on an average of the similarity degrees selected by a predetermined number in descending order of the similarity degrees among all the similarity degrees derived for each piece of the training data.

6. The information processing apparatus according to claim 1, wherein:
the training data includes a combination of training input data and training correct answer data serving as output data in a case where the training input data is input to the teacher model, and
the at least one processor is configured to derive the reliability degree based on a loss value representing a magnitude of an error of output data obtained by inputting the training input data to the teacher model with respect to the training correct answer data.

7. The information processing apparatus according to claim 1, wherein the at least one processor is configured to derive the reliability degree based on an evaluation value representing a degree of matching of output data obtained by inputting evaluation input data included in evaluation data to the teacher model with evaluation correct answer data, the evaluation data including a combination of the evaluation input data and the evaluation correct answer data serving as output data in a case where the evaluation input data is input to the teacher model.

8. The information processing apparatus according to claim 1, wherein the at least one processor is configured to train the student model such that a loss value representing a magnitude of an error of the output data obtained by inputting the sample data to the student model with respect to the output target is minimized.

9. The information processing apparatus according to claim 6, wherein the at least one processor is configured to derive the loss value using at least one measure of cross entropy, Kullback-Leibler divergence, or mean squared error.

10. The information processing apparatus according to claim 1, wherein:
the teacher model and the student model are models in which an input is text data and an output is classification for each character included in the text data,
the training data includes a combination of text data and classification for each character included in the text data, and
the sample data includes text data.

11. The information processing apparatus according to claim 10, wherein the at least one processor is configured to derive the reliability degree based on a similarity degree with respect to at least one of a meaning, a structure, or appearance words between the text data included in the training data and the text data included in the sample data.

12. The information processing apparatus according to claim 10, wherein:
the teacher model and the student model are models in which an input is text data and an output is a probability distribution of an NE label indicating a type of named entity represented by the character, which is given for each character included in the text data, and
the at least one processor is configured to:
derive an output target based on the probability distribution of the NE label obtained by inputting the sample data to the teacher model and the reliability degree; and
train the student model such that the probability distribution of the NE label obtained by inputting the sample data to the student model approaches the output target.

13. The information processing apparatus according to claim 10, wherein:
the teacher model and the student model are models in which an input is text data and an output is a probability distribution of a BIO label indicating whether the character corresponds to any of a start position, an internal position, and an external position of the named entity, which is given for each character included in the text data, and
the at least one processor is configured to:
derive an output target based on the probability distribution of the BIO label obtained by inputting the sample data to the teacher model and the reliability degree; and
train the student model such that the probability distribution of the BIO label obtained by inputting the sample data to the student model approaches the output target.

14. An information processing method comprising:
deriving a reliability degree of a trained teacher model based on training data used for training the teacher model and predetermined sample data;
deriving an output target based on output data obtained by inputting the sample data to the teacher model and the reliability degree; and
training a student model such that output data obtained by inputting the sample data to the student model approaches the output target.

15. A non-transitory computer-readable storage medium storing an information processing program for causing a computer to execute a process comprising:
deriving a reliability degree of a trained teacher model based on training data used for training the teacher model and predetermined sample data;
deriving an output target based on output data obtained by inputting the sample data to the teacher model and the reliability degree; and
training a student model such that output data obtained by inputting the sample data to the student model approaches the output target.
